(19) United States
(12) Patent Application Publication
(10) Pub. No.: US 2009/0242363 A1
(43) Pub. Date: Oct. 1, 2009

(54) Pressure switch

(76) Inventor: Tze-Chiang Lin, Dadu Township (TW)

Correspondence Address: PRO-TECHTOR INTERNATIONAL SERVICES, 20775 NORADA CT., SARATOGA, CA, 95070, US

(21) Appl. No.: 12/080,102

(22) Filed: Mar. 31, 2008

(51) Int. Cl. H01H 35/26

(52) U.S. Cl. 200/81.5

(57) ABSTRACT

The present invention relates to a type of pressure switch, particularly a type of pressure switch having a hand-controlled device, using a control rod on the hand control device to directly drive a second driving plate to move up and down, thereby to effortlessly open and close a release valve and power of the pressure switch.

### BACKGROUND OF THE INVENTION

A pressure switch is the electrical switch of pressure operation, used to control the pressure inside the air cylinder of an electrically driven air compressor, to turn it between two preset pressure settings. The pressure switch has a release vale, serving to avoid overload starting of the air compressor, and a control rod to manually open the release valve of the air compressor cylinder, to execute release operation, meanwhile cut off power to the air compressor, to stop operation of the air compressor. A four-way base connector opening facilitates installation of the release valve and pressure gage.

The present invention relates to a type of pressure switch, particularly a type of pressure switch having a hand-controlled device, using a control rod on the hand control device to directly drive a second driving plate to move up and down, thereby to effortlessly turn on and off the release valve and power.

As shown in FIGS. 1 to 4, the conventional pressure switch 1 comprises a base 11, a lower casing 12, an upper casing 13, an exterior casing 14, a first driving plate 21, a second driving plate 22, a third driving plate 23, a tension spring 24, a pressure adjustment spring set 25, a fine-tune spring set 26, a release valve 27 and a control rod 28; wherein the base 11 has an air inlet 111, a first pressure release hole 112, a second pressure release hole 113 and a third pressure release hole 114, and a pneumatic rubber block 1120 is joined to an outside of the first pressure release hole 112, wherein the lower casing 12 has a through hole 121 on its bottom, the first side wall 122 of the lower casing 12 has a mobile hole 123, protruding outwardly on top of the mobile hole 123 is a hole unit 124, protruding outwardly on bottom of the mobile hole 123 is a flapper 125; positioned on the second side wall 126 of the lower casing 12 is a shaft hole 127, the bottom of the lower casing 12 is joined to the top of the base 11, the through hole 121 on the bottom of the lower casing 12 is positioned on top of the pneumatic rubber block 1120 joined externally to the first pressure release hole 112 of the base 11; wherein the upper casing 13 is made of plastic material, positioned at the center on top of the upper casing 13 is a mobile hole 131, positioned on the front side of the mobile hole 131 are two spring troughs 132, 133, positioned inside the spring trough 132 are two matching snap troughs 1321, 1322, the upper outlet 1323 of the spring trough appropriately retracts inwardly, positioned in the upper section of the spring trough 133 is an inside screw thread 1331, the inside margin of the lower outlet 1332 of the spring trough 133 appropriately retracts inwardly, positioned on one side of the mobile hole 131 is an on off circuit 134, the on off circuit 134 comprising of a contact point 1341 and a conductive piece 1342; positioned on another side of the mobile hole 131 is also an on off circuit 135, the on off circuit 135 comprising of a contact point 1351 and a conductive piece 1352. On the inside margin of the upper casing, between the two on off circuits 134, 135 are two matching slide rails (not shown in the drawings); the upper casing 13 is fitted to the top of the lower casing 12, the upper casing 13 and the lower casing 12 are combined and screwed to the top of the base 11; wherein the exterior casing 14 is fitted to the top of the upper casing 13 and the lower casing 12, the exterior casing 14 and the lower casing 12 are combined and screwed to the top of the base 11; wherein the bottom at the center of the first driving plate 21 forms downwardly a protrusion 211, positioned at the front section of the first driving plate 21 is a sleeve 212, one side of the sleeve 212 bending upwardly 90 degrees to have a snap trough 213, another side of the sleeve 212 bending upwardly 90 degrees then bending outwardly 90 degrees to form a wing part 214; the first driving plate 21 is positioned inside the lower casing 12, the protrusion 211 of the first driving plate 21 is justly accommodated in the through hole 121 on bottom of the lower casing 12, and is pressed against the pneumatic rubber block 1120 at a bottom side of the through hole 121 on the bottom of the lower casing 12; wherein one side of the second driving plate 22 extends outwardly to form an extension arm 221, positioned at the center of the second driving plate 22 is a spring piece 222 at an upward angle of approximately 45 degrees, at the center of the second driving plate 22 and one side of the spring piece 222 is a snap hole 223; the second driving plate 22 is positioned on top of the first driving plate 21, the extension arm 221 of the second driving plate 22 extends out of the mobile hole 123 on the first side wall 122 of the lower casing 12, and between the hole unit 124 protruding outwardly on top of the mobile hole 123 and the flapper 125 protruding outwardly from the bottom of the mobile hole 123; wherein the hook end 241 of the tension spring 24 is hooked to the snap trough 213 of the first driving plate 21, another hook end 242 of the tension spring 24 is hooked to the snap hole 223 of the second driving plate 22; wherein the third driving plate 23 is an insulating plate made of bakelite, the top of the third driving plate 23 is a slide block 231 protruding upwardly, the bottom of the third driving plate 23 is an activation block 232 protruding downwardly, the front of the third driving plate 23 is a slide block 233 protruding forwardly, the rear of the third driving plate 23 is a slide block 234 protruding backwardly, the left and right sides of the third driving plate 23 extend outwardly to form respectively a pressure rod 235, 236; the third driving plate 23 is positioned between the upper casing 13 and the second driving plate 22, the slide block 231 of the third driving plate 23 is fitted into the mobile hole 131 of the upper casing, the slide blocks 233, 234 at the front and rear of the third driving plate 23 are correspondingly fitted to two corresponding slide rails (not shown in the drawings) of the upper casing 13, the pressure rod 235 of the third driving plate 23 is pressed against the lower margin of the conductive piece 1342 of the on off circuit 134 of the upper casing 13, the pressure rod 236 of the third driving plate 23 is pressed against the lower margin of the conductive piece 1352 of the on off circuit 135 of the upper casing, the bottom end of the activation block 232 of the third driving plate 23 is pressed against the upper margin of the spring plate 222 at the center of the second driving plate 22; wherein the pressure adjusting spring set 25 comprises of a pressure adjusting screw 251, a double-wing nut 252 and a compression spring 253, the pressure adjusting spring set 25 is positioned inside the spring trough of the upper casing 13, the bottom of the pressure adjusting screw 251 of the pressure adjusting spring set 25 is fitted to the outside margin of the sleeve 212 at the front section of the first driving plate 21, using the depth penetrated by the pressure adjusting screw 251 into the double-wing nut 252 to adjust the pressure applied by the compression spring 253 on the first driving plate 21; wherein the fine-tune spring set 26 comprises of a pressure adjusting screw 261, a compression spring 262 and a plastic terminal 263, the fine-tune spring set 26 is positioned inside the spring trough of the upper casing, the plastic terminal 263 of the fine-tune spring set is pressing against the upper margin of the wing part 214 at the front section of the first driving plate 21, using the depth penetrated by the pressure adjusting screw 261 into the inside screw thread 1331 in upper section of the spring trough 133, to adjust the pressure applied by the fine-tune applied by the compression spring 262 through the plastic terminal 263; wherein the release valve is joined to the hole unit 124 of the first side wall 122 of the lower casing by a nut 270, the air release piston rod 271 of the release valve 27 appropriately extends toward the lower part of the hole unit 124, at the front of the mobile hole 123 of the first side wall 122 of the lower casing 12, and pressing against the upper margin of the extension arm 221 of the second driving plate 22; the air cylinder (not shown in the drawings) of the air compressor (not shown in the drawings) is joined to the air inlet hole 111 of the base 11, the air from the air cylinder enters through the air inlet hole 111 of the base 11 to the first pressure release hole 112, the second pressure release hole 113 and the third pressure release hole 114 of the base 11, with an air pipe (not shown in the drawings) connected to the pressure release hole 113 and the release valve 27 of the base 11, and a air pipe (not shown in the drawings) connected to the third pressure release hole 114 and the pressure gage (not shown in the drawings) of the third pressure release hole 114 of the base 11; wherein the control rod 28 is shaped in a figure of “7”, the hook end 281 of the control rod 28 penetrates into the shaft hole 127 of the second side wall 126 of the lower casing 12, pressing against the lower margin of the wing part 214 at the front section of the first driving plate 21, the shaft rod 282 of the control rod is fitted to the shaft hole 127 of the second side wall 126 of the lower casing 12, the handle 283 of the control rod 28 is positioned outside the shaft hole 127 of the second side wall 126 of the lower casing 12; lifting up the handle 283 of the control rod 28 will make the hook end 281 of the control rod 28 push the first driving plate 21 to move upward, the compression spring 253 of the pressure adjusting spring set 25 and the compression spring 262 of the fine-tune spring set 26 drive the extension arm 221 of the second driving plate 22, push up the air release piston rod 271 of the release valve 27 to open the release valve 27 to leak air; and push the third driving plate 23 to move upward, drive the pressure rod 235 of the third driving plate 23, push the conductive piece 1342 away from the contact point 1341 of the on off circuit 134 of the upper casing 13 to move upward, meanwhile driving the pressure rod 236 of the third driving plate 23, pushing the conductive piece 1352 away from the contact point 1351 of the on off circuit 135 of the upper casing 13 to move upward, to turn off power and stop operation of the air compressor (not shown in the drawings).

As described above, in the conventional type of pressure switch 1, lifting the handle 283 of the control rod 28 requires a very powerful force to make the hook end 281 of the control rod 28 push the first driving plate 21 to move the first driving plate 21 upward, counteracting the compression spring 253 of the pressure adjusting spring set 25 and the compression spring 262 of the fine-tune spring set 26, resulting in oblique inclination of the compression spring 253 of the pressure adjusting spring set 25 after being compressed, and cracking of the upper casing 13 made of plastic material after being compressed.

### SUMMARY OF THE INVENTION

To make improvement on the shortcoming of the aforementioned conventional pressure switch, the present invention provides a type of pressure switch comprising of a base, a lower casing, an upper casing, an exterior casing, a first driving plate, a second driving plate, a third driving plate, a tension spring, a pressure adjusting spring set, a fine-tune spring set, a release valve and a control rod, characterized in the hand control device comprising of the control rod and the second driving plate, wherein the hook end of the control rod is joined to the second driving plate, using the control rod to directly drive the second driving plate to move up and down, to effortlessly turn on and off the release valve and power of the pressure switch; which can make improvement on the shortcoming in the hand control device of the conventional type of pressure switch comprising of a control rod and a first driving plate, which requires an extremely large force to turn on and off the release valve and power of the pressure switch, counteracting the pressure adjusting spring set on the first driving plate and the compression spring of the fine-tune spring set, resulting in oblique inclination of the compression spring of the pressure adjusting spring set after being compressed, and cracking of the upper casing made of plastic material after being compressed.

The primary objective of the present invention is to provide a type of pressure switch that is capable of making improvement on the shortcoming of the conventional type of pressure switch using a hand control device comprising of a first driving plate and a control rod and requiring an extremely large force to turn on and off the release valve and power of the pressure switch, counteracting the compression spring of the conventional pressure switch positioned on top of the first driving plate, resulting in oblique inclination of the compression spring of the pressure adjusting spring set after being compressed, and cracking of the upper casing made of plastic material after being compressed.

Another objective of the present invention is to provide a type of pressure switch which uses a hand control device to turn off the release valve and power of the pressure switch, without touching the compression springs of the pressure adjusting spring set and fine-tune spring set installed in the pressure switch.

A further objective of the present invention is to provide a type of pressure switch that is equipped with a hand control device comprising of a hook end of a control rod joined to a second driving plate, wherein the hook end of the control rod is joined to the second driving plate, using to the control rod to directly drive the second driving plate to move up and down, to effortlessly turn on and off the release valve and power of the pressure switch.

### BRIEF DESCRIPTION OF THE DRAWINGS

FIG. 1 is an exploded view of the conventional pressure switch.

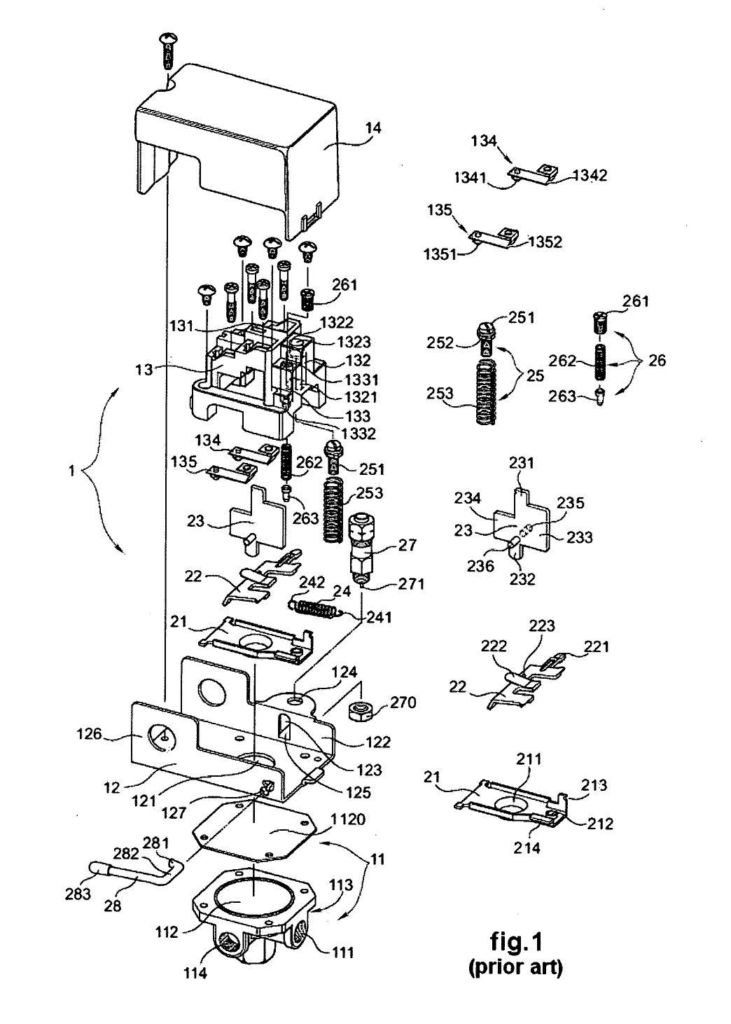

FIG. 2 is a perspective view of the conventional pressure switch.

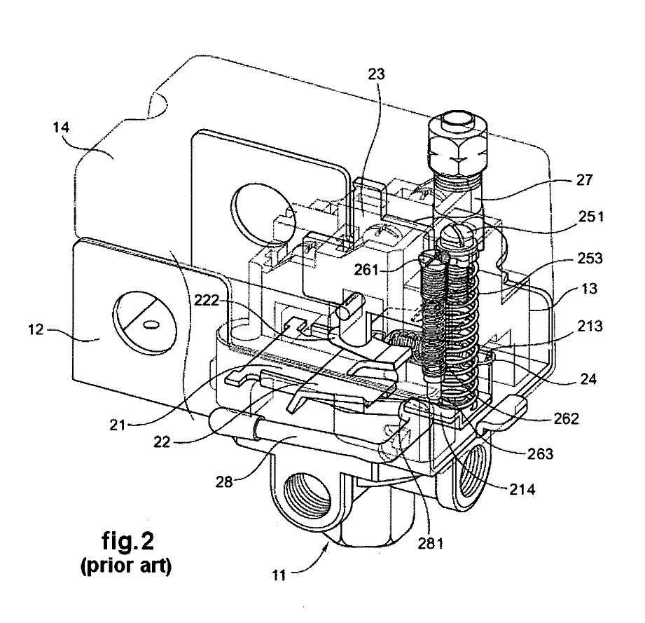

FIG. 3 is a schematic view of the conventional pressure switch in switching off operation.

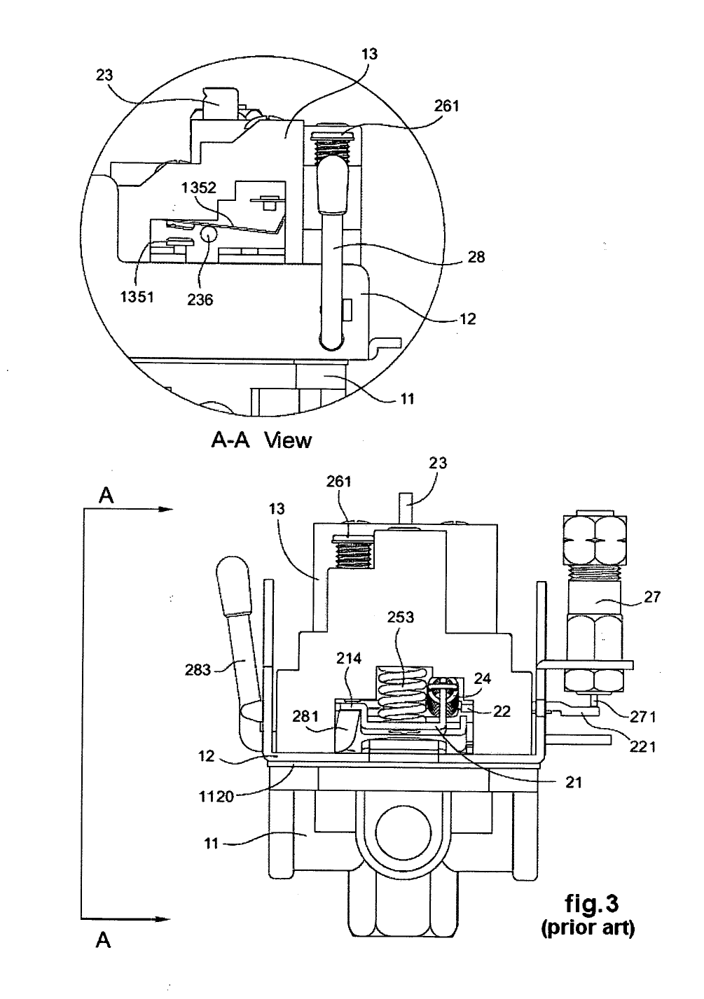

FIG. 4 is a schematic view of the conventional pressure switch in switch on operation.

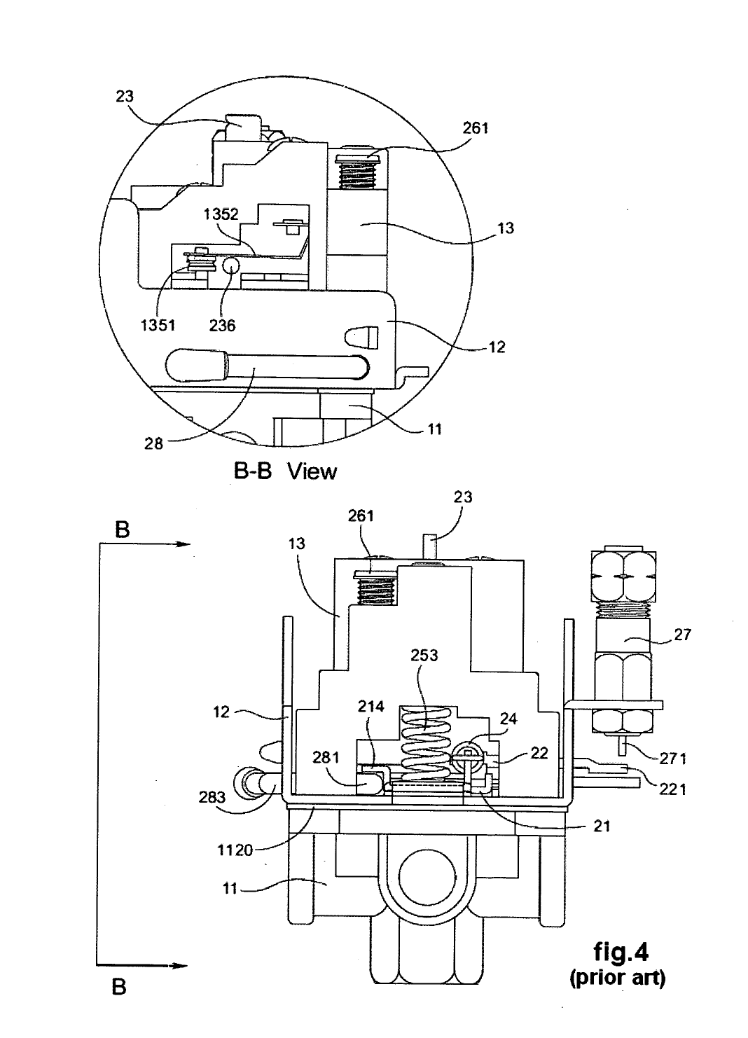

FIG. 5 is an exploded view of the present invention of pressure switch.

FIG. 6 is a perspective view of the present invention of pressure switch.

FIG. 7 is a schematic view of the present invention of pressure switch in switching off operation.

FIG. 8 is a schematic view of the present invention of pressure switch in switching on operation.

### DETAILED DESCRIPTION OF THE PREFERRED EMBODIMENTS

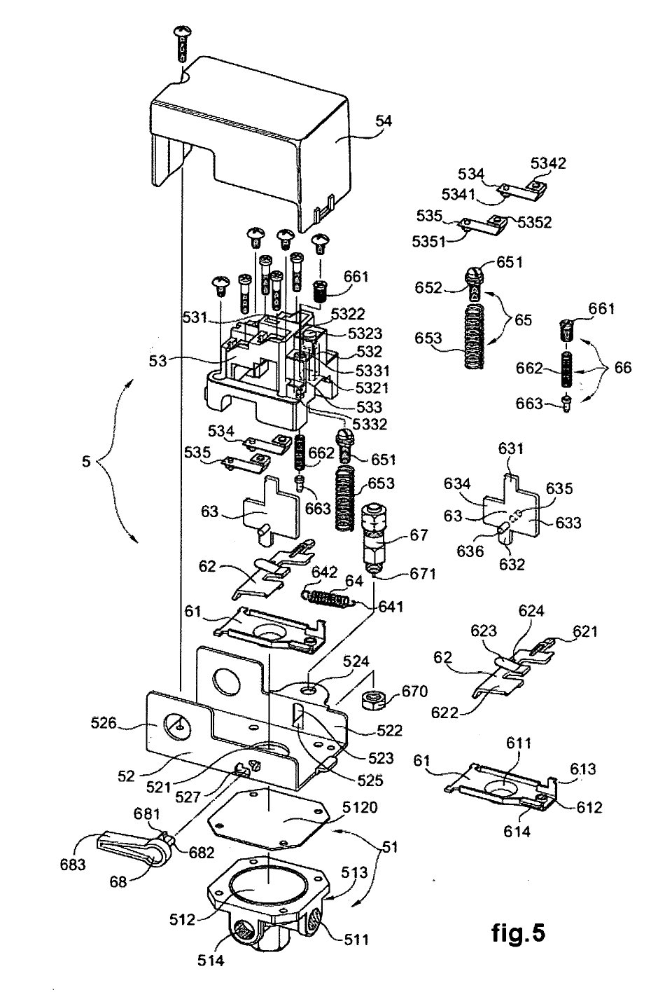

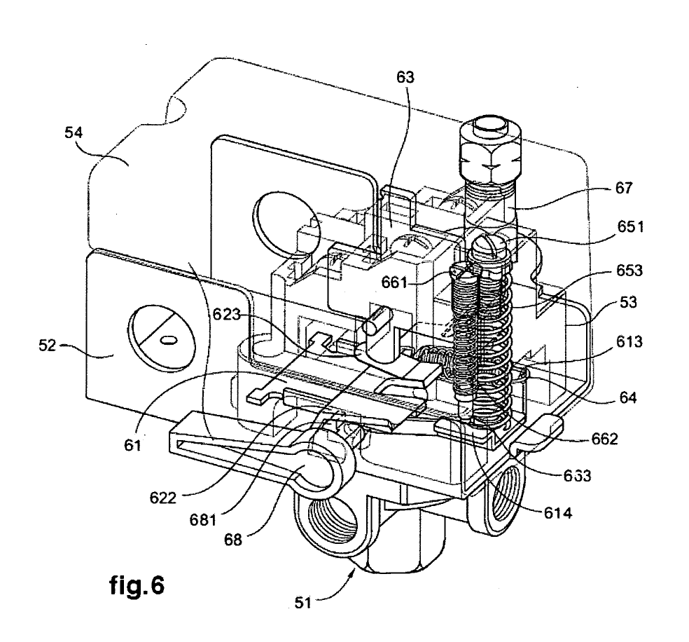

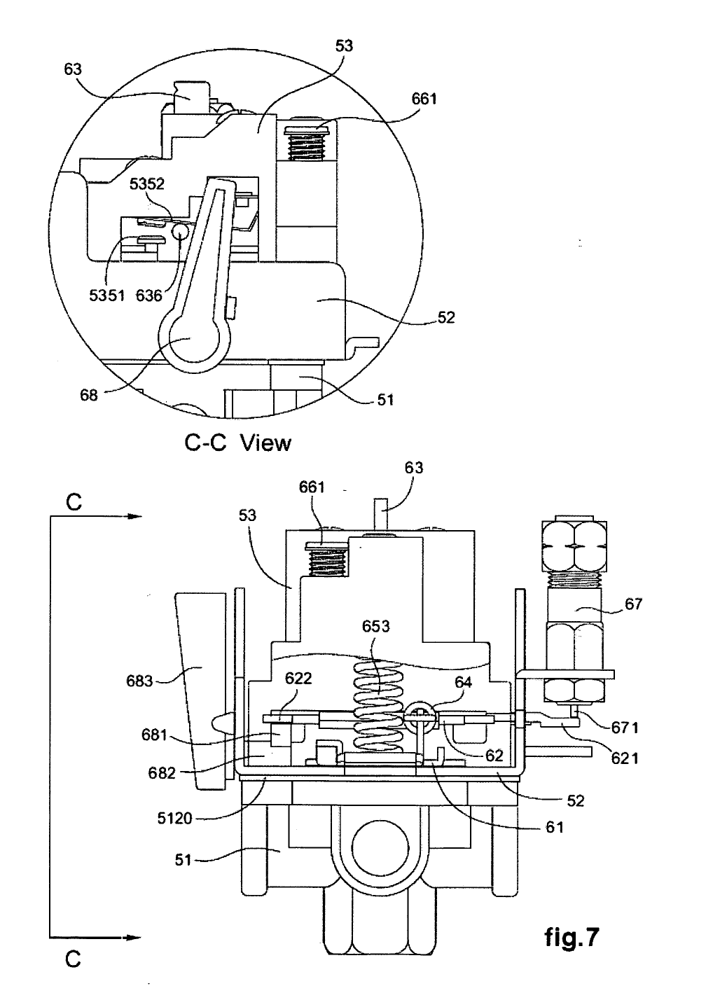

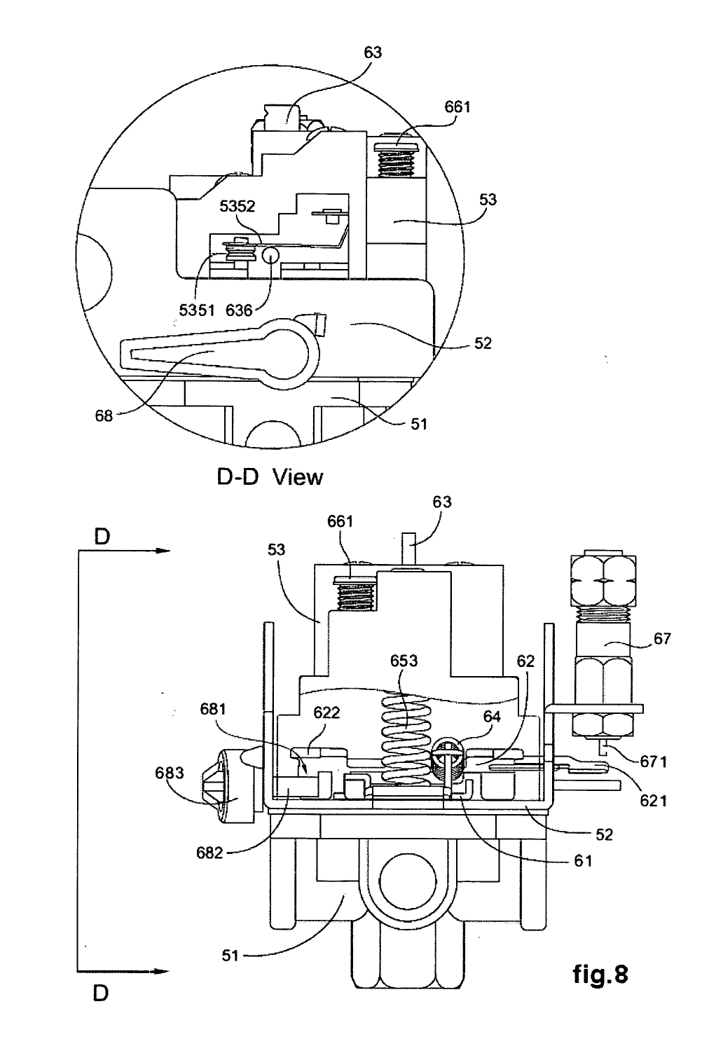

As shown in FIGS. 5 through 8, the present invention of pressure switch 5 comprises a base 51, a lower casing 52, an upper casing 53, an exterior casing 54, a first driving plate 61, a second driving plate 62, a third driving plate 63, a tension spring 64, a pressure adjusting spring set 65, a fine-tune spring set 66, a release valve 67 and a control rod 68; wherein the base 51 has an air inlet hole 511, a first pressure release hole 512, a second pressure release hole 513 and a third pressure release hole 514, the first pressure release hole 512 of the base 51 is joined externally to a pneumatic rubber block 5120; wherein the lower casing 52 has a through hole 521 on its bottom, the first side wall 522 of the lower casing 52 has a mobile hole 523, the mobile hole 523 has a hole unit 524 protruding outwardly on its top side, the mobile hole 523 has a flapper 525 protruding outwardly on its bottom side, the second side wall 526 of the lower casing 52 has a shaft hole 527, the bottom of the lower casing 52 is joined to the top of the base 51, the through hole 521 on the bottom of the lower casing 52 is joined to the top side of the pneumatic rubber block 5120 which is joined externally to the first pressure release hole 512 of the base 51; wherein the upper casing 53 is made of plastic material, at the center on top of the upper casing 53 is a mobile hole 531, on the front side of the mobile hole 531 are two spring troughs 532, 533, inside the spring trough 532 are two matching snap troughs 5321, 5322, the inner margin of the upper outlet 5323 of the spring trough 532 retracts appropriately inward, on the upper section of the spring trough 533 is an inside screw thread 5331, the lower outlet 5332 of the spring trough 533 retracts appropriately inward, on one side of the mobile hole 531 is an on off circuit 534, the on off circuit 534 consisting of a contact point 5341 and a conductive piece 5352; on the inside margin of the upper casing 53 and between the on off circuits 534, 535 are two corresponding slide rails (not shown in drawings); the upper casing 53 is fitted on top of the lower casing 52, the upper casing and the lower casing 52 are jointly screwed to the top of the base 51; wherein the exterior casing 54 is fitted to the top of the upper casing 53 and the lower casing 52, the exterior casing 54 and the lower casing 52 are jointly screwed to the top of the base 51; wherein the central bottom of the first driving plate 61 curves downward to form a protrusion 611, the front section of the first driving plate 61 has a sleeve 612, one side of the sleeve 612 bending upward 90 degrees to form a snap trough 613, another side of the sleeve 612 bending upward 90 degrees then again bending outwardly 90 degrees to form a wing part 614; the first driving plate 61 is positioned inside the lower casing 52, the protrusion 611 of the first driving plate 61 is justly accommodated in the through hole 521 on the bottom of the lower casing 52 and in contact with the pneumatic rubber block 5120 below the through hole 521 on the bottom of the lower casing 52; wherein one side of the second driving plate 62 has an extension arm 621 extending outwardly, another side of the second driving plate 62 forms a wing part 622 bending slightly downward, the center of the second driving plate 62 has a spring plate 623 at an upward angle of approximately 45 degrees, the center part of the second driving plate 62 and one side of the spring plate 623 has a snap hole 624; the second driving plate 62 is positioned on top of the first driving plate 61, the second driving plate 62 is slightly wider than the first driving plate 61, the wing part 622 of the second driving plate 62 extends further than the wing part 614 of the first driving plate 61, the extension arm 621 of the second driving plate 62 extends out of the mobile hole 523 of the first side wall 522 of the lower casing 52, between the hole unit 524 protruding outwardly on top of the mobile hole 523 and the flapper 525 protruding outwardly on bottom of the mobile hole 523; wherein the hook end 641 of the tension spring 64 is hooked to the snap trough 613 of the first driving plate 61, and another hook end of the tension spring 64 is hooked to the snap hole 623 of the second driving plate 62; wherein the third driving plate 63 is an insulated plate made of bakelite, the top of the third driving plate 63 is a slide block 631 protruding upwardly, the bottom part of the third driving plate 63 is an activation block 632 protruding downward, the front of the third driving plate 63 is a slide block 633 protruding forward, the rear of the third driving plate 63 is a slide block 634 protruding backward, the left and right sides of the third driving plate 63 extending outwardly to form respectively a pressure rod 635, 636; the third driving plate 63 is positioned between the upper casing 53 and the second driving plate 62, the slide block 631 of the third driving plate 63 is fitted into the mobile hole 131 of the upper casing 53, the slide blocks 633, 634 on the front and rear of the third driving plate 63 are correspondingly fitted to the two corresponding slide rails (not shown in drawings) of the upper casing 53, the pressure rod 635 of the third driving plate 63 is pressed against the lower margin of the conductive piece 5342 of the on off circuit 534 of the upper casing 53, the pressure rod 636 of the third driving plate 63 is pressed against the lower margin of the conductive piece 5352 of the on off circuit 535 of the upper casing 53, the activation block 632 of the third driving plate 63 is pressed against the upper margin of the spring piece 622 at the center of the second driving plate 62; wherein the pressure adjusting spring set 65 comprises a pressure adjusting screw 651, a double-wing nut 652 and a compression spring 653, the pressure adjusting spring set 65 is positioned inside the spring trough 532 of the upper casing 53, the bottom of the pressure adjusting screw 651 of the pressure adjusting spring set 65 is fitted to the outer margin of the sleeve 612 in the front section of the first driving plate 61, using the depth penetrated by the pressure adjusting screw 651 into the double-wing nut 652 to adjust the pressure applied by the pressure the compression spring 653 on the first driving plate 61; wherein the fine-tune spring set 66 comprises a pressure adjusting screw 661, a compression spring 662 and a plastic terminal 663, the fine-tune spring set 66 is positioned inside the spring trough 533 of the upper casing 53, the plastic terminal 663 of the fine-tune spring set 66 is pressed against the upper margin of the wing part 614 at the front section of the first driving plate 61, using the depth penetrated by the pressure adjusting screw 661 into the screw thread 5331 in the upper section of the spring trough 533, to fine tune the pressure applied by the compression spring 662 through the plastic terminal 663 on the first driving plate 61; wherein the release valve 67 is joined by a nut 670 to the hole unit 524 on the first side wall 522 of the lower casing 52, the air release piston rod 671 of the release valve 67 appropriately extends downward toward the hole unit 524, at the front of the mobile hole 523 of the first side wall 522 of the lower casing 52, and is pressing against the upper margin of the extension arm 621 of the second driving plate 62; the air cylinder (not shown in the drawings) of the air compressor (not shown in the drawings) is joined to the air inlet hole 511 of the base 51, air in the air cylinder enters through the air inlet hole 511 of the base 11 into the first pressure release hole 512, the second pressure release hole 513 and third pressure release hole 514 on the base 51, there is a air pipe (not shown in drawings) connected to the second pressure release hole 513 and the release valve 67 on the base 51, there is an air pipe (not shown in the drawings) connected to the third pressure release hole 514 and the pressure gauge (not shown in the drawings) on the base 51; wherein the control rod 68 is formed in the shape of figure “7”, the hook end 681 of the control rod 68 penetrates the shaft hole 527 of the second side wall 526 of the lower casing 52, and is pressed against the lower margin of the wing part 622 of the second driving plate 62, the shaft rod 682 of the control rod 68 is fitted to the shaft hole 527 of the second side wall 526 of the lower casing 52, the handle of the control rod 68 is positioned outside the shaft hole 527 of the second side wall 526 of the lower casing 52; lifting the handle 683 of the control rod 68 upward will make the hook end 681 of the control rod 68 push the second driving plate 62 to move upward, driving the extension arm 621 of the second driving plate 62, and pushing the air release piston rod 671 of the release valve 67 to open up the release valve 67 to leak air; and push up the third driving plate 63 to move upward, thereby driving the pressure rod 635 of the third driving plate 63, pushing the conductive piece 5342 away from the contact point 5341 of the on off circuit 534 of the upper casing 53 to move upward, meanwhile driving the pressure rod 636 of the third driving plate 63, and pushing the conductive piece 5352 away from the contact point 5351 of the on off circuit 535 of the upper casing 53 to move upward, thereby turning off power of the pressure switch, and stop operation of the air compressor (not shown in the drawings).

As described above, the components comprising the present invention of pressure switch 5, including the base 51, the lower casing 52, the upper casing 53, the exterior casing 54, the first driving plate 61, the third driving plate 63, the tension spring 64, the pressure adjusting spring set 65, the fine-tune spring set 66 and the release valve 67 are exactly the same as the components comprising the conventional pressure switch 1, including the base 11, the lower casing 12, the upper casing 13, the exterior casing 14, the first driving plate 21, the third driving plate 23, the tension spring 24, the pressure adjusting spring set 25, the fine-tune spring set 26 and the release valve 27; the preferred embodiment of the present invention of pressure switch 5 is characterized in that, in the hand control device composed by the control rod 68 and the second driving plate 62, the second driving plate 62 is slightly wider than the first driving plate 61, one side of the second driving plate 62 forms a wing part 622, and the hook end 681 of the control rod 68 being positioned on the lower margin of the wing part 622 of the second driving plate 62, using the control rod 68 to directly push the second driving plate 62 to move up and down, thereby to drive the extension arm 621 of the second driving plate 62, push the air release piston rod 671 of the release valve 67 to turn on or off the release valve 67 of the pressure switch; and drive the pressure rods 635, 636 of the third driving plate 63 and turn on and off power of the pressure switch.

Since the preferred embodiment of the present invention of pressure switch 5 uses the control rod 68 to directly push the second driving plate 62 to move up and down, driving the extension arm 621 of the second driving plate 62, pushing the air release piston rod 671 of the release valve 67 to turn on and off the release valve 67 of the pressure switch, thereby driving the pressure rods 635, 636 of the third driving plate 63 to turn on and off power of the pressure switch, which will not involve contact with the compression spring 651 of the pressure adjusting spring set 65 and the compression spring 661 of the fine-tune spring set 66, therefore it requires not much effort to turn on and off the control rod 68; which is capable of making improvement on the shortcomings in the conventional type of pressure switch 1 that requires an extremely large force by using a hand control device comprising of the control rod 28 and the first driving plate 21 to push the first driving plate 21 to move upward, to counteract the compression tension 253 of the pressure adjusting spring set 25 and the compression spring 262 of the fine-tune spring set 26, resulting in oblique inclination of the compression spring 253 of the pressure adjusting spring set 25 after being compressed, and cracking of the upper casing 13 made of plastic material after being compressed.

The above description serves to describe some of the preferred embodiments of the present invention, which should not be used to restrict or limit the present invention which may include a variety of transformations, modifications and applications without departing from the spirit of the present invention, including the hand control device with equivalent performance by production of the control rod in one of many different geological configurations, joined to the second driving plate by one of various mechanical means, and other similar methods should be included in the scope of the subject patent right.

What is claimed is;

1. A type of pressure switch, comprising a base, a lower casing, an upper casing, an exterior casing, a first driving plate, a second driving plate, a third driving plate, a tension spring, a pressure adjusting spring set, fine-tune spring set, a release valve and a control rod, wherein the control rod and the second driving plate comprising a hand control device that is capable of effortlessly turning on and off the release valve and power of the pressure switch.

2. The pressure switch claimed in claim 1, wherein a bottom of the lower casing has a through hole, a first side wall of the lower casing has a mobile hole, the mobile hole has a hole unit that protrudes outwardly from a top position of the mobile hole, the mobile hole has a flapper that protrudes outwardly from a bottom position of the mobile hole, a second side wall of the lower casing has a shaft hole, and a bottom part of the lower casing is joined to a top side of the base.

3. The pressure switch claimed in claim 1, wherein the upper casing is joined to the top side of the lower casing, and the upper casing and the lower casing are combined and screwed to the top side of the base.

4. The pressure switch claimed in claim 1, wherein the exterior casing is joined to the upper side of the upper casing and the lower casing, and the exterior casing and the lower casing are combined and screwed to the upper side of the base.

5. The pressure switch claimed in claim 1, wherein the first driving plate is installed inside the lower casing.

6. The pressure switch claimed in claim 1, wherein an extension arm extends outwardly from one side of the second driving plate, the extension arm of the second driving plate extending out of the mobile hole on the first side wall of the lower casing, between the hole unit that protrudes outwardly from the top position of the mobile hole and the flapper that protrudes outwardly from the bottom position of the mobile hole, the second driving plate is positioned on a top side of the first driving plate.

7. The pressure switch claimed in claim 1, wherein a hook end of the tension spring is hooked onto the first driving plate, and another hook end of the tension spring is hooked onto the second driving plate.

8. The pressure switch claimed in claim 1, wherein the third driving plate is installed between the upper casing and the second driving plate.

9. The pressure switch claimed in claim 1, wherein the pressure adjusting spring set is composed of a pressure adjusting screw, a double-wing nut and a compression spring, and the pressure adjusting spring is installed inside the upper casing.

10. The pressure switch claimed in claim 1, wherein the fine-tune spring set is composed of a pressure adjusting screw, a compression spring and a plastic terminal, and the fine-tune spring set is installed inside the upper casing.

11. The pressure switch claimed in claim 1, wherein the release valve is joined by a nut to a hole unit on the first side wall of the lower casing.

12. The pressure switch claimed in claim 1, wherein the control rod is shaped as a figure “7”, a hook end of the control rod is inserted into a shaft hole on the second side wall of the lower casing and joined to the second driving plate, a shaft rod of the control rod is joined to a shaft hole on the second side wall of the lower casing, and a handle of the control rod is installed outside a shaft hole on the second side wall of the lower casing.

13. The pressure switch claimed in claim 1, wherein the hook end of the control rod is joined to the second driving plate, using the control rod to directly drive and move the second driving plate up and down.
